(19) United States
(12) Patent Application Publication
(10) Pub. No.: US 2016/0124411 A1
(43) Pub. Date: May 5, 2016

(54) DISTRIBUTED ENERGY DEMAND MANAGEMENT

(71) Applicant: QUALCOMM Incorporated, San Diego, CA (US)

(72) Inventors: Peerapol Tinnakornsrisuphap, San Diego, CA (US); Shengbo Chen, San Diego, CA (US); Rashid Ahmed Akbar Attar, San Diego, CA (US)

(21) Appl. No.: 14/697,137

(22) Filed: Apr. 27, 2015

Related U.S. Application Data
(60) Provisional application No. 62/073,507, filed on Oct. 31, 2014.

(51) Int. Cl. G05B 19/042

(52) U.S. Cl. CPC G05B 19/0428; G05B 2219/2639

(57) ABSTRACT

Distributed energy demand management mechanisms for a distributed energy network are disclosed. In one example, a local energy controller of a local energy system determines projected energy demand information for a plurality of energy devices of the local energy system based on energy pricing information received from a central energy coordinator. The local energy controller modifies an energy consumption schedule during an energy pricing transition period based on energy access control information received from the central energy coordinator to manage a projected energy demand increase during the energy pricing transition period of the distributed energy network. In one example, the central energy coordinator determines the energy pricing information for the distributed energy network based on energy supply information and the projected energy demand information. The central energy coordinator determines the energy access control information based on the projected energy demand increase during the energy pricing transition period.

### RELATED APPLICATIONS

This application claims the priority benefit of U.S. Provisional Application Ser. No. 62/073,507 filed Oct. 31, 2014.

### TECHNICAL FIELD

Embodiments of the disclosure generally relate to the field of distributed energy networks, and, more particularly, to managing energy demand in a distributed energy network.

### BACKGROUND

Electrical utility companies implement energy supply management mechanisms to ensure that sufficient energy supply is available to meet the energy demand of a distributed energy network. The distributed energy network (or electrical grid) may include the energy producers/generators, energy distribution infrastructure (e.g., transmission lines and transformers), and the energy consumers or local energy systems (e.g., home/office energy systems). A distributed energy network typically has energy generation plants that are off-line (or running at reduced capacity) and energy reserves. These can be used to supply additional energy to the distributed energy network to satisfy energy demand increases. However, the additional energy from the plants or reserves may be insufficient during peak energy demand, thus introducing instability into the energy distribution infrastructure.

Electrical utility companies may also implement energy demand management mechanisms to reduce the energy demand in the distributed energy network during time periods of peak energy demand. For example, an electrical utility company may utilize dynamic energy pricing schemes and/or time-of-use energy pricing schemes to reduce the energy demand during typical time periods of peak demand (i.e., peak times). Dynamic pricing schemes are typically used to determine energy prices for a relatively short period of time (e.g., 24 hours or less). The energy prices that are determined using dynamic energy pricing schemes can be changed in real-time based on real-time energy demand information. Time-of-use energy pricing schemes typically provide customers a schedule of energy prices for a longer period of time, such as a week, a month, or a year. Electrical utility companies may use dynamic and time-of-use pricing schemes to set relatively high energy prices for peak times and relatively low energy prices for off-peak times. Although dynamic and time-of-use pricing schemes may reduce the energy demand during typical peak times, these pricing schemes may create energy demand spikes during certain off-peak times due to more favorable pricing. For example, when there is a transition period in energy pricing from a peak energy price to a low energy price, a large number of customers may shift a portion of their energy consumption to start during this transition period. When a large number of customers follow the same patterns of shifting their energy consumption, energy demand spikes can occur in the distributed energy network. Energy demand spikes can also introduce instability into the energy distribution infrastructure of the distributed energy network.

### SUMMARY

Various embodiments for managing energy demand and energy consumption in a distributed energy network are disclosed. In one embodiment, a local energy controller of a local energy system determines energy pricing information of a distributed energy network for a first time period. The local energy controller determines projected energy demand information for a plurality of energy devices of the local energy system for the first time period based, at least in part, on the energy pricing information for the first time period. The local energy controller provides the projected energy demand information to a central energy coordinator of the distributed energy network.

In one embodiment, the central energy coordinator of the distributed energy network receives the projected energy demand information from a plurality of energy controllers of the distributed energy network. The central energy coordinator determines energy supply information for the distributed energy network. The central energy coordinator determines energy pricing information for the distributed energy network based, at least in part, on the projected energy demand information and the energy supply information. The central energy coordinator determines energy access control information based, at least in part, on a projected energy demand increase during an energy pricing transition period.

In one embodiment, the local energy controller receives the energy access control information from the central energy coordinator that indicates the energy pricing transition period having the projected energy demand increase. The local energy controller modifies an energy consumption schedule of the local energy system during the energy pricing transition period based, at least in part, on the energy access control information to manage the projected energy demand increase during the energy pricing transition period of the distributed energy network.

### BRIEF DESCRIPTION OF THE DRAWINGS

The present embodiments may be better understood, and numerous objects, features, and advantages made apparent to those skilled in the art by referencing the accompanying drawings.

FIG. 1 is an example block diagram of a distributed energy network including mechanisms for managing energy demand in the distributed energy network.

FIG. 2 depicts a graph showing one example of dynamic energy pricing information provided by a central energy coordinator.

FIG. 3 is an example block diagram of a local energy system including a local energy controller and energy devices.

FIG. 4 is a flow diagram illustrating example operations for determining projected energy demand at a local energy system of a distributed energy network.

FIG. 5 is a flow diagram illustrating example operations for distributed energy demand management.

FIG. 6 is a flow diagram illustrating example operations for managing energy consumption in a distributed energy network.

FIG. 7 depicts graphs illustrating an example of energy consumption management by local energy controllers to modify energy consumption schedules based on an energy access control parameter.

FIG. 8 is an example block diagram of an electronic device including an energy manager.

### DESCRIPTION OF EMBODIMENT(S)

The description that follows includes example systems, methods, techniques, instruction sequences, and computer program products that describe various embodiments of the present disclosure. However, it is understood that the described embodiments may be practiced without these specific details. For instance, although some examples refer to energy systems in homes, in other examples the energy systems described herein can be implemented in offices, schools, hospitals, and other types of buildings. In other instances, well-known instruction instances, protocols, structures and techniques have not been shown in detail in order not to obfuscate the description.

Electrical utility companies (also referred to herein as energy providers) may use energy pricing schemes to reduce the energy demand of a distributed energy network during time periods of peak energy demand. For example, energy providers may set relatively high energy prices for peak demand time periods (i.e., peak times) and relatively low energy prices for off-peak demand time periods (i.e., off-peak times). Energy providers may also offer promotional free energy or discounted energy prices for selected time periods. However, energy demand spikes may occur in the distributed energy network when a large number of customers shift a portion of their energy consumption to start at approximately the same time during a transition period in energy pricing. For example, if energy pricing transitions from a relatively high energy price to a relatively low energy price, customers with electric vehicles may delay charging their electric vehicles to obtain the lower energy price. Some customers may also delay running their pool pumps, dishwashers, or other energy consuming devices until the energy price transitions to the low energy price. When such shifts in energy consumption occur at approximately the same time, energy demand spikes can cause large-scale or small-scale failures in the energy distribution infrastructure, which is typically not well equipped to handle energy demand spikes. For example, if there is a high concentration of electric vehicles in one neighborhood, the transformer that services the neighborhood may fail if it is not designed to handle such instantaneous spikes in energy demand.

In some embodiments, energy providers can implement energy demand management mechanisms that work in conjunction with energy pricing schemes to manage the energy demand of the distributed energy network and reduce or “smooth out” energy demand spikes. The energy providers can exchange a variety of energy-related information with local energy systems to intelligently manage the energy demand in the distributed energy network, while still allowing the local energy systems to utilize cost-effective energy consumption schedules. For example, an energy provider can receive projected energy demand information from the local energy controllers that manage the local energy systems of homes, businesses, schools, and other buildings. The local energy controllers may determine the projected energy demand information based on energy pricing information received from the energy provider and energy consumption information associated with the local energy system. In one example, the projected energy demand information may include a projected energy demand schedule for the energy devices of the local energy system in hourly increments (or other suitable time increments) for a particular time period, such as a day, a week, or any other suitable time period. The energy provider may aggregate the projected energy demand information (e.g., the projected energy demand schedules) from various local energy controllers to determine an overall energy demand schedule for the distributed energy network. The energy provider can also determine energy supply information for the distributed energy network. The energy supply information may indicate the amount of energy that can be generated and the amount of energy that is available in energy reserves during different time periods for the distributed energy network.

The energy provider may determine energy pricing information based on the projected energy demand information and the energy supply information. The energy pricing information can be, for example, dynamic energy pricing information and/or time-of-use energy pricing schedules. The energy provider may provide the energy pricing information to the local energy controllers. The local energy controllers can determine cost-effective energy consumption schedules for the local energy systems based on the energy pricing information. The energy consumption schedules of the local energy systems can be a starting point for energy pricing and energy demand management. In addition, the energy consumption schedules may be modified to address energy demand spikes and improve the overall energy demand management and stability of the distributed energy network.

In some embodiments, the energy provider may use the energy pricing information and projected energy demand information to predict an occurrence of energy demand spikes during energy pricing transition periods. An energy pricing transition period that can result in an energy demand spike is a period of time when the energy prices change from a relatively high price to a relatively low price (or vice versa). An energy demand spike is a sharp increase in energy demand within a relatively short amount of time (e.g., one or two hours). For example, an energy demand spike can be defined as a rate of change in energy demand that is greater than a threshold rate. The energy provider may predict the occurrence of an energy demand spike during an energy pricing transition period after detecting significant changes in the projected energy demand during the energy pricing transition period. For example, based on the projected energy demand information received from the local energy controllers, the energy provider may predict the occurrence of an energy demand spike when the change in the projected energy demand from the beginning of the energy pricing transition period to the end of the energy pricing transition period is greater than a threshold. The energy provider may determine energy access control information based on characteristics of the energy pricing transition periods and characteristics of the predicted energy demand spikes. The energy provider may provide the energy access control information to the local energy controllers. As will be further described below, the energy access control information may include ramp rate control parameters, token bucket parameters, and/or energy access probability parameters. The local energy controllers may vary the energy consumption schedules during the energy pricing transition periods based on the energy access control information to reduce or smooth out the energy demand spikes of the distributed energy network. For example, the energy access control information may be used reduce the energy demand spikes in the distributed energy network by more evenly distributing the energy consumption of the local energy systems during the energy pricing transition periods.

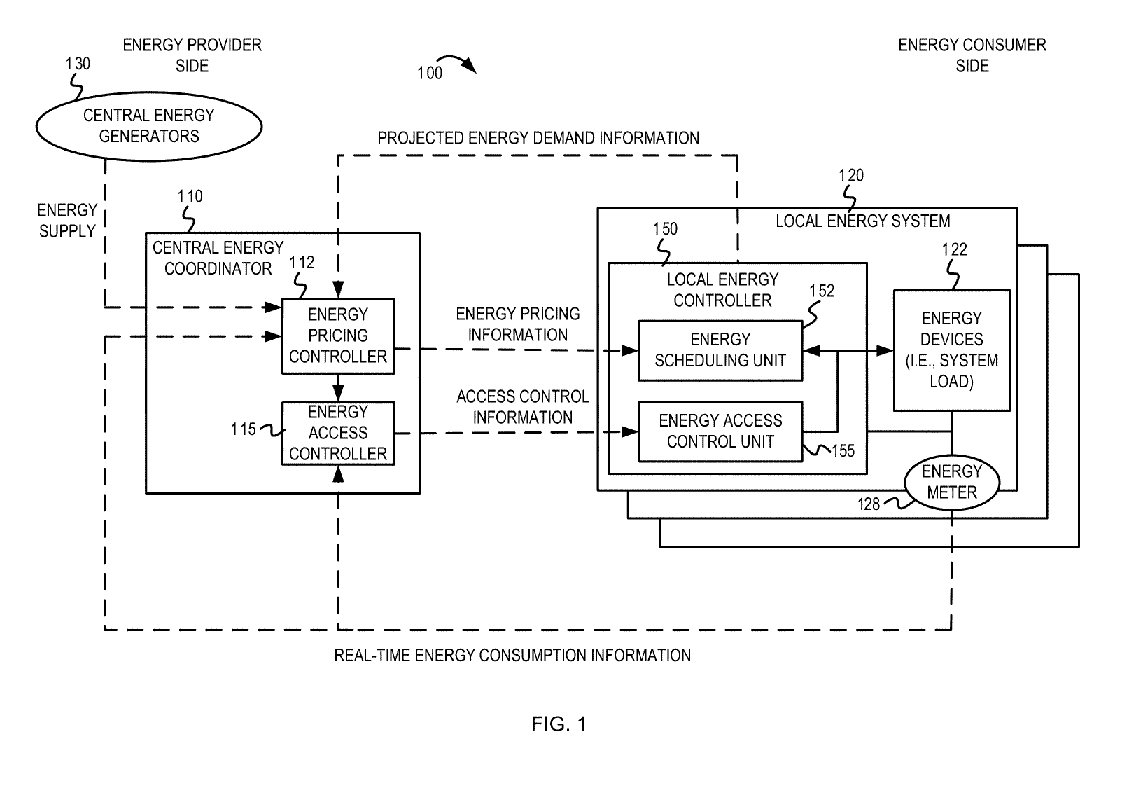

FIG. 1 is an example block diagram of a distributed energy network 100 including mechanisms for managing energy demand in the distributed energy network 100. The distributed energy network 100 includes a central energy coordinator 110 and a plurality of local energy systems 120. The central energy coordinator 110 can be implemented at the energy provider (e.g., at the electrical utility company using one or more web servers). Each of the local energy systems 120 may be located in a home, office building, hospital, school, multi-family building, or any other type of site with energy consuming devices. A local energy system 120 may include a local energy controller 150, a plurality of energy devices 122, and an energy meter 128. The energy devices 122 (also referred to as energy consuming devices or the system load) may be various types or categories of devices that consume energy in the local energy system 120. For example, the energy devices 122 may include a heating, ventilating, and air conditioning (HVAC) system, a water heater, a pool pump, smart lighting devices, smart appliances, electric vehicles, and other suitable energy consuming devices. Although not shown, the local energy system 120 may also include local energy generators (e.g., solar panels), and local energy reserves (e.g., batteries). The distributed energy network 100 may also include central energy generators 130. The central energy generators 130 may be electrical power plants that generate energy for distribution to the local energy systems 120. The central energy generators 130 may also include renewable energy sources and reserves, such as solar, wind, hydro-electric, and nuclear energy sources and reserves.

The central energy coordinator 110 and the local energy controllers 150 may be communicatively coupled using wired and/or wireless communication links. For example, the central energy coordinator 110 and the local energy controller 150 can communicate using wired protocols (e.g., Transmission Control Protocol/Internet Protocol (TCP/IP) or powerline communication (PLC) protocols) and/or wireless protocols (e.g., Long-Term Evolution (LTE) protocols or Worldwide Interoperability for Microwave Access (WiMAX) protocols). The central energy coordinator 110 may also communicate with the central energy generators 130 using similar communication mechanisms.

The central energy coordinator 110 may work in conjunction with the local energy controllers 150 to implement energy demand management mechanisms to effectively manage the energy demand of the distributed energy network 100 and to reduce (or smooth out) the energy demand spikes. The central energy coordinator 110 and the local energy controllers 150 can exchange energy-related information to manage both short-term and long-term energy demands and energy consumption in the distributed energy network 100. In some embodiments, the central energy coordinator 110 may include an energy pricing controller 112 and an energy access controller 115. The local energy controller 150 may include an energy scheduling unit 152 and an energy access control unit 155. The energy pricing controller 112 may determine the price of energy for the distributed energy network 100 and provide energy pricing information to the local energy controllers 150. Typically, the price of energy is represented as the price (in cents) per kilowatt hour (kWh). The energy pricing controller 112 may determine short-term energy pricing information, such as dynamic energy pricing information that indicates the projected energy pricing schedule for a particular time period, such as a day, a week, or any other suitable time period. The dynamic energy pricing information can also indicate the price of energy in real-time for a relatively short amount of time (e.g., 24 hours or less). For example, dynamic energy pricing data may indicate the projected energy pricing schedule for the next week and also accurately provide real-time energy pricing for the next few hours (e.g., $0.08/kWh for the next 3 hours). As will be further described below, the dynamic energy pricing information can be determined based on the energy supply and demand of the distributed energy network 100. In some implementations, the energy pricing controller 112 may also store longer-term energy pricing information, such as a time-of-use energy pricing schedules that do not change based on the energy supply or demand of the distributed energy network 100. The time-of-use energy pricing schedule may indicate the default price of energy in hourly increments (or any other suitable time increments) for a week, a month, or multiple of days/weeks/months (or any other suitable time period).

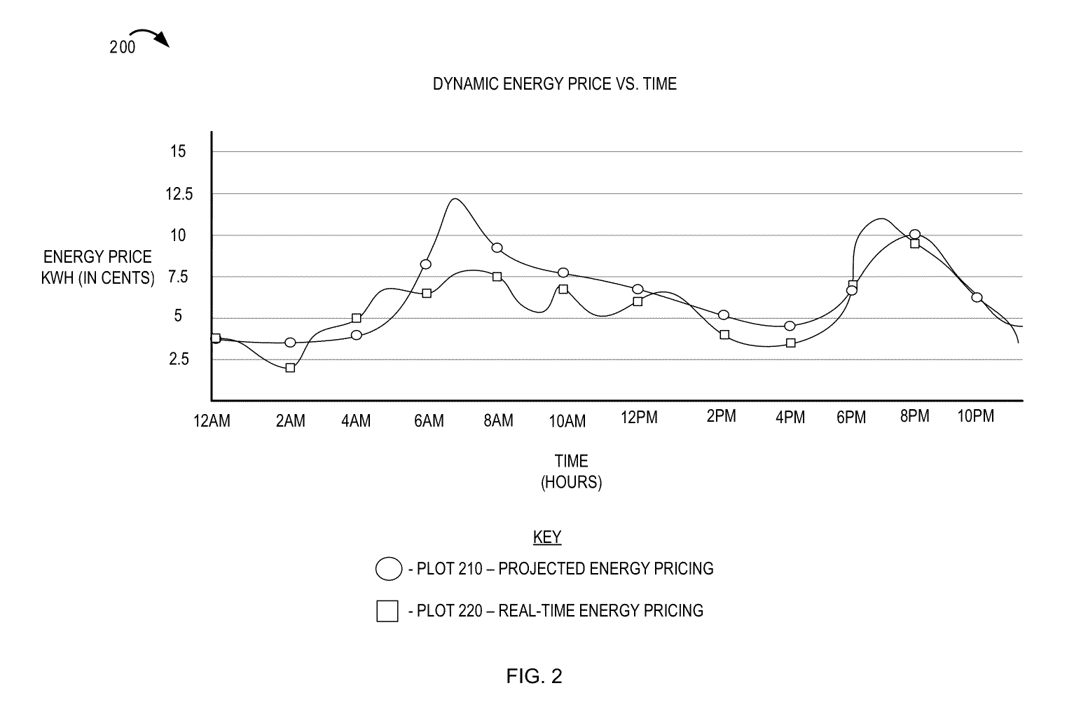

FIG. 2 is a graph 200 showing one example of dynamic energy pricing information for a typical day that may be provided from the central energy coordinator 110 to the local energy controllers 150. The price per kWh (from $0.00/kWh-$0.15/kWh) is shown from 12:00 am to 11:00 pm. The dynamic energy pricing information may include a projected energy pricing schedule and real-time energy pricing information. The plot 210 is one example of a 24-hour portion of a projected energy pricing schedule that can be provided to the local energy controllers 150 in advance (e.g., one day or one week in advance). The projected energy pricing schedule can indicate the projected price of energy in minute increments or hourly increments (or any other suitable time increments) for a particular time period (e.g., a day, week, or month). The plot 220 is one example of real-time energy pricing information that can be provided to the local energy controllers 150 periodically throughout the day. For example, the real-time energy pricing information may be provided to the local energy controllers 150 every 15 minutes (or every hour) and may provide energy prices for the next three hours from the time of receipt. For example, the real-time energy pricing information received at 1 pm can indicate the real-time energy prices between 1 pm and 4 pm, and the real-time energy pricing information received at 1:15 pm can indicate the real-time energy prices between 1:15 pm and 4:15 pm. The central energy coordinator 110 can provide the real-time energy pricing information to the local energy controllers 150 periodically throughout the date because the real-time energy prices can change within a short period of time. As shown in plot 220, the real-time energy pricing information may indicate any differences in the actual price of energy from the projected energy pricing schedule. The real-time energy pricing information can also be stored to track the history of the actual energy pricing for the past day, week or any suitable time period. As illustrated, the plots 210 and 220 have similar energy pricing trends, but the real-time energy pricing data points of plot 220 can more accurately reflect the short-term cost of energy than the projected energy pricing data points of plot 210.

The energy pricing controller 112 may determine the dynamic energy pricing information based on an aggregate of the projected energy demand information received from the local energy controllers 150 and the energy supply information received from the central energy generators 130. In some implementations, the energy pricing controller 112 may receive updated projections of the energy demand from the local energy controllers 150 once a day (or other suitable time interval), and may also receive real-time energy consumption information from the energy meters 128 periodically throughout the day. The energy pricing controller 112 may determine time periods of relatively high energy prices and time periods of relatively low energy prices based on the short-term and long-term projected energy demands. In one example, the energy pricing controller 112 may determine that the aggregate of the projected energy demand information indicates that the time periods of peak energy demand will be between 7-8 am and between 7-9 pm. Therefore, as shown in FIG. 2, the energy pricing controller 112 can set the daily peak energy prices during the time periods that are projected to have peak energy demand. In some implementations, the energy pricing controller 112 may determine the aggregate energy demand and the energy pricing information based on the projected energy demand information received from a subset of the local energy controllers 150. For example, the energy pricing controller 112 may use a random sampling of the projected energy demand information received from the local energy controllers 150 to project the energy demand of the distributed energy network 100. In another example, the energy pricing controller 112 may use the projected energy demand information received within a specific time interval from a subset of the local energy controllers 150 to project the energy demand of the distributed energy network 100.

The energy scheduling unit 152 of each local energy controller 150 may forecast or project the energy demand of the corresponding local energy system 120. As described above, the projected energy demand information may be provided to the central energy coordinator 110 to be used for determining the energy pricing information for the distributed energy network 100. In some implementations, the energy scheduling unit 152 may determine the projected energy demand information based on projections of the energy consumption of the energy devices of the local energy system 120 and projections of the local energy generation and local energy reserves of the local energy system 120. For example, the projected energy demand information may include a projected energy demand schedule that is determined based on a projected energy consumption schedule of the energy devices of the local energy system 120 and a projected schedule of local energy generation and use of local energy reserves of the local energy system 120.

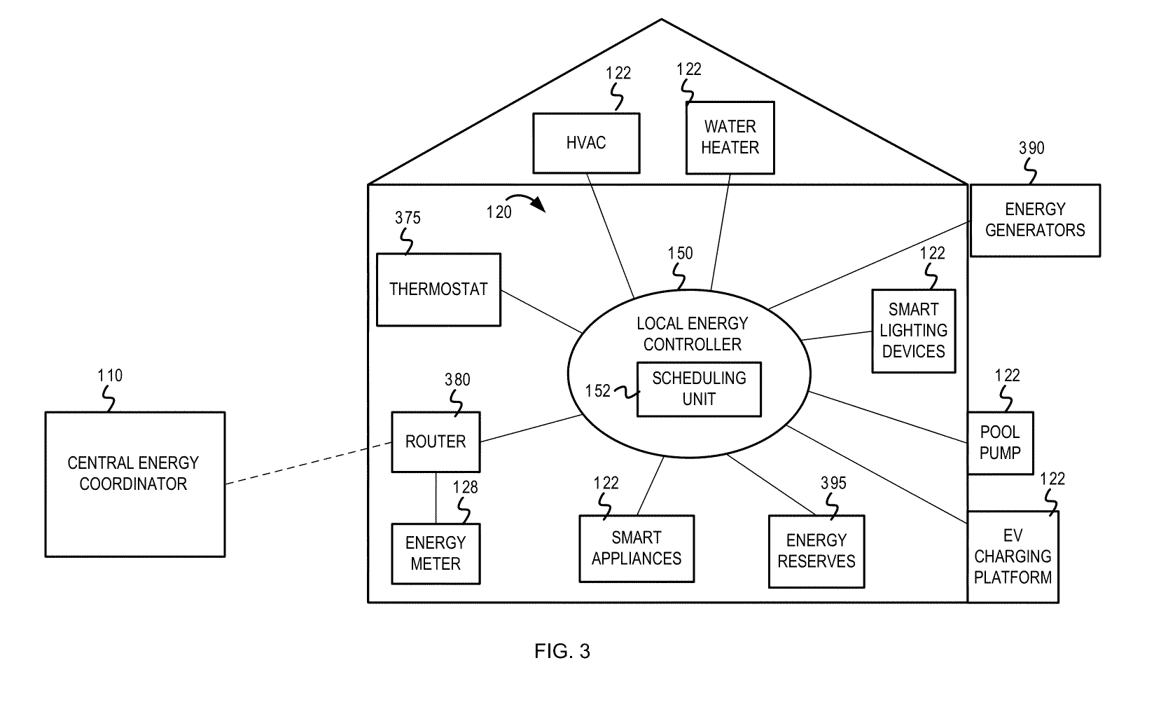

FIG. 3 is one example block diagram of the local energy system 120 including the local energy controller 150 and energy devices 122. As shown in FIG. 3, the energy devices 122 may be various types or categories of devices that consume energy, such as HVAC systems, water heaters, pool pumps, smart lighting devices, smart appliances, and electric vehicle (EV) charging platforms. The local energy system 120 may also include a smart thermostat 375, a smart router 380, an energy meter 128, energy generators 390 (e.g., solar panels), and energy reserves 395 (e.g., battery backups). The local energy controller 150 may include the energy scheduling unit 152. In some implementations, the local energy controller 150 can be implemented as a separate device within the local energy system 120, within the smart thermostat 375, within the smart router 380, or in a distributed manner across two or more devices in the local energy system 120. The energy controller 150 may be communicatively coupled with the energy devices 122, the thermostat 375, the router 380, the energy generators 390 and the energy reserves 395 using wired and/or wireless communication network links. For example, the devices can communicate using wired protocols (e.g., Ethernet or PLC protocols) via a wired communication medium, and/or communicate using wireless protocols (e.g., Institute of Electrical and Electronics Engineers (IEEE) 802.11 protocols or BLUETOOTH® protocols) via a wireless communication medium.

The energy scheduling unit 152 may determine the projected energy demand information for a particular time period (e.g., a week) based on the energy pricing information (e.g., the projected energy pricing schedule) during the time period. In one implementation, the energy scheduling unit 152 may determine the projected energy demand information for the time period based on an energy consumption schedule of the energy devices 122 of the local energy system 120 during the time period. The energy consumption schedule can be determined based, at least in part, on the projected energy pricing schedule during the time period. For example, the energy consumption schedule can be determined based on the projected energy pricing schedule, user-programmed energy consumption information, historical energy consumption information, learned user behaviors, and weather forecasts and historical data. For example, the energy scheduling unit 152 can determine the energy consumption schedule based on the above-referenced factors for a particular time period, such as a day, a week, a month, or multiple days/weeks/months. The energy consumption schedule can indicate the projected energy consumption of each energy device 122 in hourly increments (or other suitable time increments) during the time period.

In one example, the user-programmed energy consumption information may be derived from the current settings in the local energy system 120, such as the user-programmed energy consumption schedules and other user preferences maintained by the local energy controller 150, the user-configured HVAC schedule in the thermostat 375, the pool pump schedule in the pool pump equipment, etc. The weather forecast and historical weather data can be obtained from the central energy coordinator 110 (or other remote system/server) via the router 380. The historical energy consumption information can be maintained by the local energy controller 150 and can indicate historical energy consumption data for each energy device for a time interval, such as the past week or month. The learned user behaviors can include user occupancy patterns and user energy usage patterns that may be derived based on historical system information that is tracked and stored by the local energy controller 150. For example, user occupancy patterns may indicate time periods during the week when the home is typically unoccupied (e.g., people leave home for work or school) and time periods when the home is typically occupied (e.g., morning routine). Energy usage patterns may indicate any daily or weekly patterns in the use of the energy devices, such as the daily charging of an electric vehicle at midnight or the daily use of a hair dryer in the morning. Using the above-referenced factors, the energy scheduling unit 152 can accurately forecast the energy demand of the local energy system 120 to generate the projected energy demand information.

In some implementations, to determine the projected energy demand information, the energy scheduling unit 152 can also consider the energy that is projected to be generated by the local energy generators 390 during the relevant time periods, and also the projected local energy reserves 395 that may be available during the relevant time periods. If energy from the local energy generators 390 and/or from the energy reserves 395 is available during a particular time period (e.g., from 5-7 pm), then the projected energy demand for that particular time period can be reduced by the amount of energy available from the local energy generators 390 and/or energy reserves 395. In one example, the projected local energy generation and projected local energy reserves may be derived based on energy generation and energy storage schedules that are managed by the local energy controller 150. In some embodiments, the projected energy demand information may include a projected energy demand schedule that indicates the total projected energy demand of the local energy system 120 for each time increment (e.g., hourly) during a time period (e.g., a week). The projected energy demand schedule may be derived based on both the energy consumption schedule of the energy devices 122 of the local energy system 120 and the projected schedule of available energy from the local energy generators 390 and local energy reserves 395. In some embodiments, in addition to indicating the total projected energy demand for each time increment in the schedule, the projected energy demand information may also indicate the energy devices that are projected to be consuming energy during each time increment, and the amount of energy demand allocated to each of the energy consuming devices. For example, the projected energy demand information may indicate that the total projected energy demand for a particular time period (e.g. from 7-8 pm) may include the energy needed to operate the HVAC system, the water heater, the dishwasher, and lighting devices. The projected energy demand information may also indicate the percentage of the energy demand that will be allocated to each of the energy consuming devices during the particular time period. The energy scheduling unit 152 can provide the projected energy demand information to the central energy coordinator 110 to be used for determining the dynamic energy pricing information.

As described above, the energy scheduling unit 152 can use the dynamic energy pricing information received from the central energy coordinator 110 to determine a cost-effective energy consumption schedule for the energy devices in the local energy system 120. In some implementations, the energy scheduling unit 152 can determine periods of low-cost energy and periods of higher-cost energy based on the dynamic energy pricing schedule, and determine whether some of the energy demand during the higher-cost time periods can be reduced. For example, the energy scheduling unit 152 can use the projected energy demand schedule to determine the energy devices that are projected to be consuming energy during the higher-cost time periods. The energy scheduling unit 152 can then reduce the projected energy demand during the higher-cost time periods by shifting some of the energy consumption to the lower-cost time periods to reduce overall energy costs.

For example, with reference to FIG. 2, the energy scheduling unit 152 can determine that the HVAC system, the water heater, the dishwasher, the pool pump, and lighting devices are projected to be consuming energy during the 7-8 pm high-cost time period. The energy scheduling unit 152 can group the energy consuming devices into three categories of devices (or loads), such as human comfort loads, time-sensitive loads, or best effort loads. Human comfort loads may include the HVAC system, water heaters, refrigerators, and lighting devices. Time-sensitive loads may include electric vehicles. Best effort loads may include a dishwasher, washer/dryer, icemaker, pool pump, and battery backup. The energy scheduling unit 152 can determine that the dishwasher and the pool pump are best effort loads that are projected to be operating during the 7-8 pm high-cost time period. The energy scheduling unit 152 can also determine that these best effort loads are time shiftable (or deferrable) loads that can be moved to a lower-cost time period in the schedule. For example, when determining a cost-effective energy consumption schedule, the energy scheduling unit 152 can schedule the operation of the dishwasher, the pool pump, and other time shiftable loads during a low-cost time period (e.g., during the 11 pm-2 am time period shown in FIG. 2). In some implementations, the energy scheduling unit 152 can further determine whether to refine the energy consumption schedule to optimize the energy costs in the short-term based on updated dynamic energy pricing schedules and/or real-time energy pricing information.

As described above, the energy scheduling unit 152 can further reduce the energy costs of the local energy system 120 when creating the energy consumption schedule by scheduling the use of the local energy generators (e.g., energy generated from solar panels) and/or the use of the energy reserves (e.g., previously stored solar energy) during higher-cost time periods. In some implementations, the energy consumption schedule may indicate in which time periods the local energy generators and/or the energy reserves will provide at least part of the energy consumed by the energy devices of the local energy system 120. The energy scheduling unit 152 may also assign different priorities to different categories of devices or loads when determining the energy consumption schedule. For example, when determining which devices or loads to schedule during the different time periods of the energy consumption schedule, the human comfort loads may have higher priority than both the time-sensitive loads and best effort loads. The time-sensitive loads may also have higher priority than the best effort loads. In one example, the human comfort loads having the highest priority may be scheduled during the higher-cost time periods, and the time-sensitive loads and the best effort loads may be scheduled during lower-cost time periods. The energy scheduling unit 152 can determine the projected energy demand information that is provided to the central energy coordinator 110 based on the energy consumption schedule and periodically update the information as necessary.

The energy access controller 115 of the central energy coordinator 110 may predict energy demand spikes in the distributed energy network based on the energy pricing information generated by the energy pricing controller 112 and the projected energy demand information received from the local energy controllers 150. The energy access controller 115 may determine energy access control parameters that can be provided to the local energy controllers 150 to reduce or smooth out the energy demand spikes. Energy demand spikes are sharp increases in energy demand within a relatively short amount of time (e.g., one or two hours). For example, energy demand spikes can be defined as a rate of change in energy demand that is greater than a threshold rate. In some cases, an energy demand spike can double or triple the energy demand of the distributed energy network within a one to three hour time period.

The energy access controller 115 may predict the occurrence of an energy demand spike during an energy pricing transition period based on detecting significant changes in the projected energy demand of the distributed energy network 100 during the energy pricing transition period. The energy pricing transition periods may be derived from the energy pricing information. For example, plot 210 of FIG. 2 illustrates a dynamic energy pricing schedule having high-cost time periods and low-cost time periods. One example of an energy pricing transition period in plot 210 is when the price of energy peaks at approximately $0.10/kWh at around 8 pm, and then the price of energy drops to approximately $0.04/kWh at around 11 pm. The energy access controller 115 may aggregate the projected energy demand information received from the local energy controllers 150. The energy access controller 115 may determine the projected energy demand at a first time instant during the energy pricing transition period (e.g., at 8 pm or at approximately the beginning of the transition period) based on the aggregate of the projected energy demand information. The energy access controller 115 may also determine the projected energy demand at a second time instant during the energy pricing transition period (e.g., at 11 pm or at approximately the end of the transition period) based on the aggregate of the projected energy demand information. In one example, the energy pricing transition period may be a time period between the first time instant having a first energy price and a second time instant having a second energy price. In one example, the energy access controller 115 may determine the time period is an energy pricing transition period when the difference between the first energy price and the second energy price exceeds a threshold (i.e., a price difference threshold).

The energy access controller 115 may then determine whether there is a significant change or difference in the projected energy demand from the first time instant to the second time instant. For example, the energy access controller 115 may predict the occurrence of an energy demand spike during the energy pricing transition period if the change in the projected energy demand from the first time instant to the second time instant is greater than a threshold. In another example, the energy access controller 115 may predict the occurrence of an energy demand spike during the energy pricing transition period if the rate of change in the energy demand (or ramp up rate) is greater than a threshold rate. Since the energy pricing schedule is provided to the local energy controllers 150, the occurrence of energy demand spikes during energy pricing transition periods may be a result of many of the local energy controllers 150 implementing cost-effective energy consumption schedules that have similar energy consumption patterns for the local energy systems 120. If many of the local energy controllers 150 implement energy consumption schedules that defer some of the energy consumption to the same low-cost time period, the aggregate of the increased energy demand during the energy pricing transition period can result in an energy demand spike in the distributed energy network 100.

The energy access controller 115 can determine the energy access control information based on characteristics of the energy pricing transition period and characteristics of the predicted energy demand spike. The energy access control information may indicate the relevant time periods associated with the energy pricing transition periods that are projected to have energy demand spikes. The energy access control information may also specify certain energy access control parameters that can be used to address the energy demand spikes. The energy access controller 115 can determine the energy access control parameters to address a predicted energy demand spike based on the ramp up rate of the predicted energy demand spike, the demand change associated with the predicted energy demand spike, and/or the types or categories of energy consuming devices (or loads) that result in the energy demand spike. For example, the ramp up rate of the predicted energy demand spike (i.e., the rate of change in the energy demand of the predicted energy demand spike) can be compared to one or more ramp up rate thresholds to determine the degree or intensity of the ramp up rate. The energy access control parameters can be determined based on the degree or intensity of the ramp up rate. In another example, different ramp up rates can be determined for the different categories or types of energy consuming devices that result in the predicted energy demand spike. For example, the energy access controller 115 can determine a first ramp up rate in the energy demand associated with a first category of devices, and a second ramp up rate in the energy demand associated with a second category of devices. The energy access control parameters for each category of device can be determined based on the corresponding ramp up rate. For example a first energy access control parameter can be assigned to energy devices in the best effort category, a second energy access control parameter can be assigned to energy devices in the human comfort category, and a third energy access control parameter can be assigned to the energy devices in the time-sensitive category.

The energy access controller 115 can determine different types of energy access control parameters, such as ramp rate control parameters, token bucket parameters, energy access probability parameters, and backoff/retry time window parameters. The energy access controller 115 can provide (or advertise) the determined energy access control parameters to the local energy controllers 150. The local energy controllers 150 can use the energy access control parameters to reduce or smooth out the energy demand spikes in the distributed energy network 100 by more evenly distributing the energy consumption of the local energy systems 120 during the energy pricing transition periods, as will be further described below.

In some implementations, the central energy coordinator 110 can receive updated projections of the energy demand information from the local energy controllers 150 and receive real-time energy consumption information from the energy meters 128. With reference to FIG. 3, in one example, a local energy controller 150 may provide the energy demand information to the router 380. An energy meter 128 may also provide the real-time energy consumption information to the router 380. The router 380 may then provide the information received from the local energy controller 150 and/or the energy meter 128 to the central energy coordinator 110 (e.g., via the Internet). In other implementations, the local energy controller 150 and/or the energy meter 128 may communicate directly with the central energy coordinator 110. Based on this information, the central energy coordinator 110 can track the projected energy demand and the real-time energy consumption during the energy pricing transition periods that were projected to have energy demand spikes to determine whether the energy demand spikes were reduced. The energy access controller 115 can determine whether to update the energy access control information if the energy demand spikes were not reduced as much as expected (e.g., the ramp up rate of the energy demand spike is still greater than a maximum rate). If the energy demand spikes were reduced as expected, the energy access controller 115 can store information about the energy access control parameters that addressed the energy demand spikes to be considered for future use.

The energy access control unit 155 of the local energy controller 150 may receive the energy access control information from the energy access controller 115 of the central energy coordinator 110. The energy access control unit 155 may determine whether to modify or adapt the energy consumption schedule that was generated by the energy scheduling unit 152 for the energy devices 122 based, at least in part, on the energy access control parameters. The energy access control unit 155 may modify the energy consumption schedule based on the energy access control parameters to address the energy demand spikes during the energy pricing transition periods and improve the stability of the distributed energy network 100. For example, ramp rate control parameters may specify a maximum rate of energy access by some or all of the energy devices 122 during the energy pricing transition periods. Based on the ramp rate control parameters, the energy access control unit 155 may change the rate of energy access by some or all of the energy devices 122 during the energy pricing transition periods. In one example, the energy access control unit 155 may reduce the rate of energy access by some or all of the energy devices 122 below the maximum rate during the energy pricing transition periods to reduce the energy demand spikes that are projected to occur during the energy pricing transition periods. In another example, token bucket parameters may specify how often a token is generated (e.g., the probability of being generated) and the token bucket size. The token bucket size may specify how many tokens an energy device 122 needs to accumulate before it is allowed to consume energy. Based on the token bucket parameters, the energy access control unit 155 may reduce the rate of energy access for some or all of the energy devices 122 by waiting until enough tokens have been accumulated (based on the token bucket size) before the energy access is admitted. In another example, backoff/retry time window parameters may specify a backoff time window or a retry time window for some or all of the energy devices 122. In this example, when an energy access by an energy device 122 is not admitted by the energy access control unit 155, the energy device 122 can wait a predetermined amount of time specified by the backoff time window (or the retry time window) before requesting another energy access. Also, the energy access control unit 155 may not admit the energy access until the backoff time window has expired in order to distribute the energy consumption during the energy pricing transition period.

Based on one or more of the energy access control parameters described above, the energy access control unit 155 may modify the energy consumption schedule during the energy pricing transition periods by distributing the start times of the energy consumption of different energy devices across longer periods of time to distribute the energy consumption more evenly and reduce the energy demand spikes. As described above, in some implementations, different energy access control parameters can be assigned to different categories or types of energy consuming devices. The energy access control unit 155 may modify the energy consumption schedule to change the timing of the energy consumption and/or change the rate of energy access in a different manner for the different categories or types of energy consuming devices.

In some implementations, in addition to (or instead of) the local energy controller 150 periodically receiving energy pricing information and energy access control information, the local energy controller 150 can request the information on demand from the central energy coordinator 110. Therefore, the local energy controller 150 may not require a persistent wired or wireless connection to the central energy coordinator 110 to exchange information. Instead, the local energy controller 150 may establish a connection with the central energy coordinator 110 periodically. In some implementations, the information may also be provided by the central energy coordinator 110 in response to certain events, such as a power outage, and/or the information may be requested by the local energy controller 150 after certain events, such as after a new load is added to the local energy system 120. Furthermore, in some implementations, the energy pricing information and the energy access control information that is obtained by the local energy controllers 150 may not be customized or targeted to each individual local energy controller and corresponding local energy system. For example, each of the local energy controllers 150 may receive the same energy pricing information and energy access control information from the central energy coordinator 110 in order to collectively address energy demand spikes in the distributed energy network.

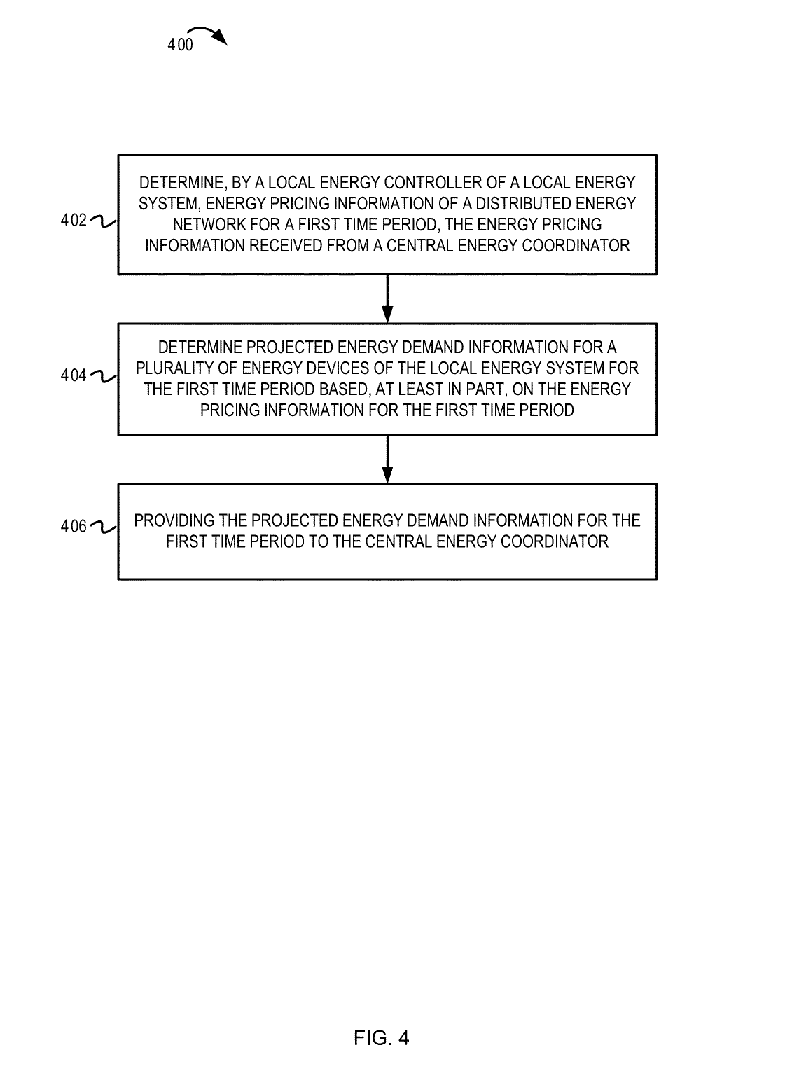

FIG. 4 is a flow diagram 400 illustrating example operations for determining projected energy demand at a local energy system of a distributed energy network. The example operations are described with reference to a central energy coordinator of an energy provider and a local energy controller of the local energy system (e.g., the central energy coordinator 110 and the local energy controller 150 shown in FIG. 1). The flow begins at block 402.

At block 402, a local energy controller of a local energy system determines energy pricing information of a distributed energy network for a first time period. In one example, the local energy controller determines the energy pricing information for the first time period after receiving the energy pricing information from a central energy coordinator of an energy provider. The energy pricing information may be a projected energy pricing schedule determined by the central energy coordinator using dynamic energy pricing schemes. The first time period may be any suitable time period in the future that the local energy controller selects for determining projected energy demand information for the energy devices in the local energy system, as will be further described below. For example, the local energy controller may select the next day, week, or month as the first time period. The local energy controller may then determine the projected energy prices for the portion of the projected energy pricing schedule that corresponds to the first time period. The local energy controller may periodically receive dynamic energy pricing information from the central energy coordinator. Therefore, the local energy controller can determine the projected energy pricing schedule for the first time period. The flow continues at block 404.

At block 404, the local energy controller determines projected energy demand information for the plurality of energy devices of the local energy system for the first time period based, at least in part, on the energy pricing information for the first time period. In one implementation, the local energy controller may determine a cost-effective energy consumption schedule for the energy devices of the local energy system based on the projected energy pricing schedule. The local energy controller may then determine the projected energy demand information for the first time period based on the energy consumption schedule during the first time period. In some implementations, the local energy controller may determine the energy consumption schedule based on the projected energy pricing schedule, energy consumption information associated with the local energy system, and user information associated with the local energy system. The energy consumption information associated with the local energy system may be user-programmed energy consumption schedules and preferences, historical energy consumption information, and local energy generation schedules. The user information may be learned user behavior, such as user occupancy patterns and user energy usage patterns. In some implementations, the local energy controller may determine the projected energy demand information for the first time period based on the energy consumption schedule during the first time period and the local energy generation schedule during the first time period. The local energy generation schedule can indicate the projected schedule for using energy generated from local energy generators (e.g., solar panels) and/or local energy reserves (e.g. batteries). Since the local energy system would partially use the locally generated energy during certain time periods specified in the local energy generation schedule, the local energy generation schedule can allow some reduction in the projected energy demand indicated by the energy consumptions schedule during those time periods. The flow continues at block 406.

At block 406, the local energy controller provides the projected energy demand information for the first time period to the central energy coordinator. In one implementation, the projected energy demand information may include a projected energy demand schedule that indicates the total projected energy demand for the local energy system during each time increment (e.g., hourly) of the first time period (e.g., the next week). In some implementations, in addition to the projected energy demand schedule, the projected energy demand information may also indicate the energy devices that are projected to be consuming energy during each time increment, and the amount (or the percentage) of the energy demand allocated to each of the energy consuming devices. As described further below, the central energy coordinator can use an aggregate of the projected energy demand information received from the local energy controllers of the distributed energy network to determine the energy pricing information for the distributed energy network.

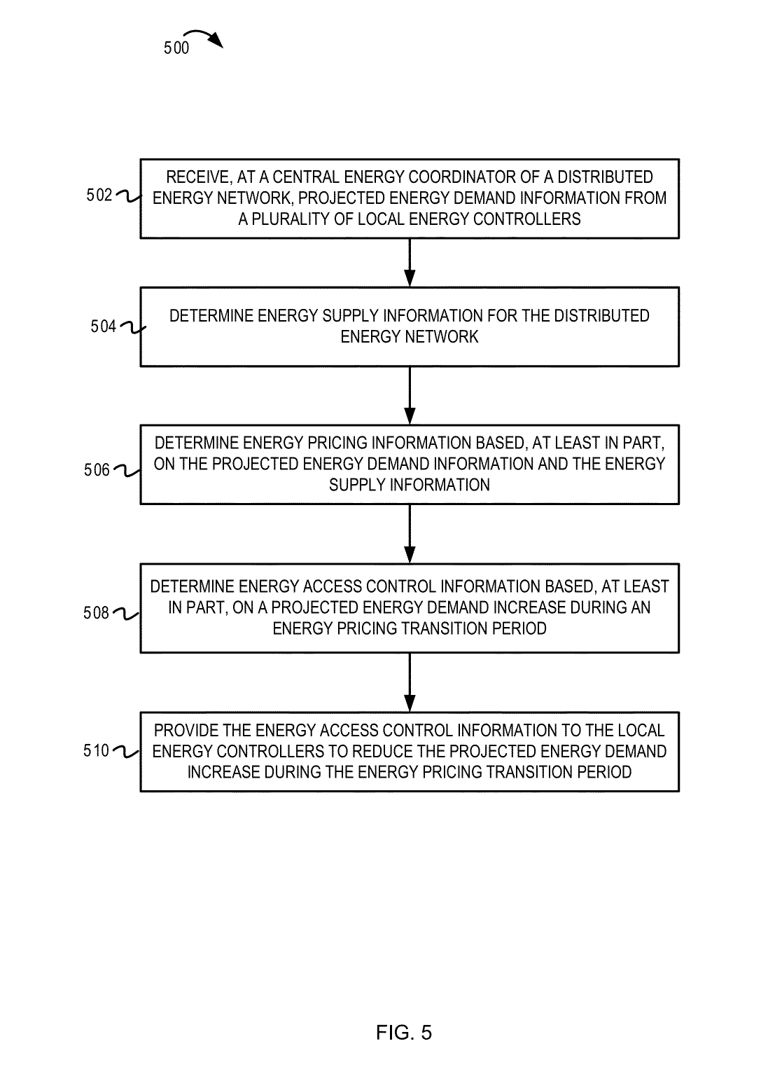

FIG. 5 is a flow diagram 500 illustrating example operations for distributed energy demand management. The example operations are described with reference to a central energy coordinator of an energy provider and a plurality of local energy controllers of local energy systems (e.g., the central energy coordinator 110 and the local energy controllers 150 shown in FIG. 1). The flow begins at block 502.

At block 502, a central energy coordinator of a distributed energy network receives projected energy demand information from a plurality of local energy controllers. The projected energy demand information may include a projected energy demand schedule that indicates the projected total energy demand for each local energy system during each time increment (e.g., hourly increments) in a particular time period (e.g., a day, a week, or a month). The projected energy demand information may also indicate the energy devices (or category of devices) that are consuming energy during each time increment, and the amount of energy that each of the energy devices (or category of devices) is consuming during each time increment. The central energy coordinator may aggregate the projected energy demand information (e.g., the energy demand schedules) to determine an overall energy demand schedule for the distributed energy network. The flow continues at block 504.

At block 504, the central energy coordinator determines energy supply information for the distributed energy network. The energy supply information may include an energy supply schedule that indicates the amount of energy that can be generated and the amount of energy that is available in energy reserves during different time periods for the distributed energy network. The energy supply information may also indicate the percentage or amount of the energy supply that is derived from renewable energy sources, such as solar, wind, and nuclear sources. The flow continues at block 506.

At block 506, the central energy coordinator determines energy pricing information based, at least in part, on the projected energy demand information and the energy supply information. The energy pricing information can be, for example, dynamic energy pricing information including a projected energy pricing schedule. The central energy coordinator may provide the energy pricing information to the local energy controllers. The central energy coordinator may provide the dynamic energy pricing information to the local energy controllers periodically (e.g., once each day). The flow continues at block 508.

At block 508, the central energy coordinator determines energy access control information based, at least in part, on a projected energy demand increase during an energy pricing transition period. As described above, the energy pricing transition period is a period of time when the energy pricing for the distributed energy network changes from a relatively high price to a relatively low price (or vice versa). The projected energy demand increase may be an energy demand spike that is projected to occur during the energy pricing transition period. In one example, the energy demand spike may be caused by a shift in energy consumption patterns of various local energy systems as a result of the favorable energy prices. In some implementations, the central energy coordinator may determine the energy access control information based on characteristics of the energy pricing transition period (e.g., duration) and characteristics of the projected energy demand spike (e.g., ramp up rate). The flow continues at block 510.

At block 510, the central energy coordinator provides the energy access control information to the local energy controllers to reduce the projected energy demand increase during the energy pricing transition period. The local energy controllers manage energy consumption schedules for the operation of the energy devices of the local energy systems. In one example, based on energy access control parameters received from the central energy coordinator, at least a subset of the local energy controllers may modify the energy consumption schedules during the energy pricing transition period to reduce or smooth out the energy demand spike that was projected to occur during the energy pricing transition period.

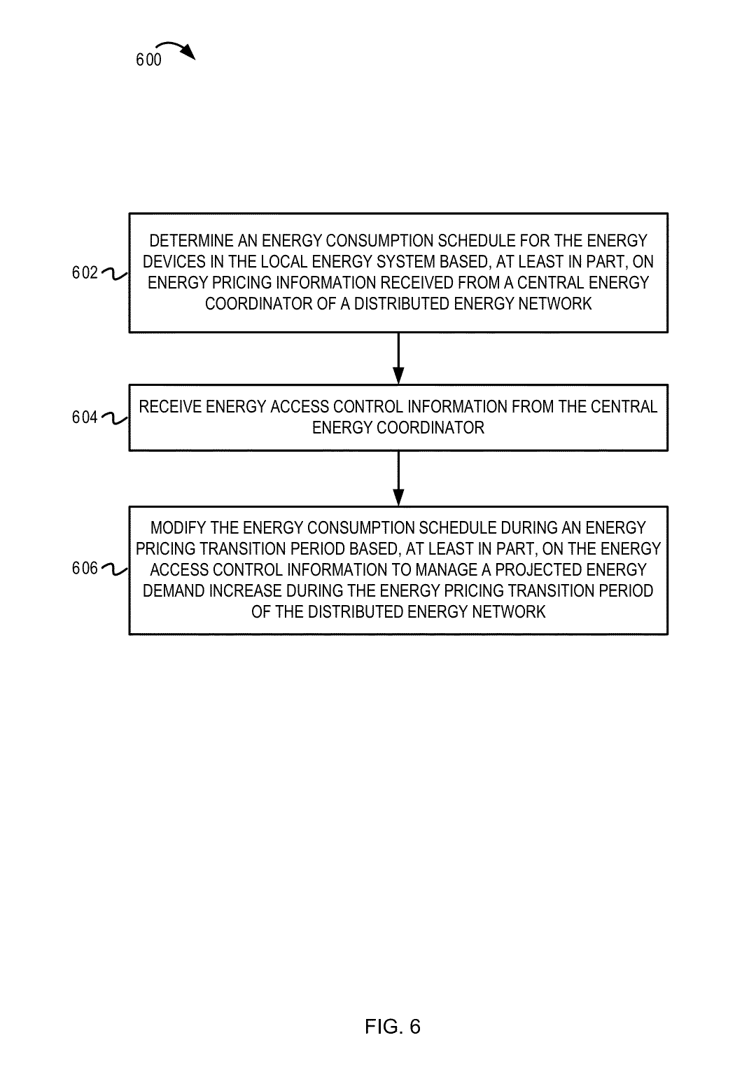

FIG. 6 is a flow diagram 600 illustrating example operations for managing energy consumption in a distributed energy network. The example operations are described with reference to a central energy coordinator of an energy provider and a local energy controller of a local energy system (e.g., the central energy coordinator 110 and the local energy controller 150 shown in FIG. 1). The flow begins at block 602.

At block 602, a local energy controller of a local energy system determines an energy consumption schedule for a plurality of energy devices in the local energy system based, at least in part, on energy pricing information received from the central energy coordinator. The local energy controller can determine periods of low-cost energy and periods of higher-cost energy based on the energy pricing information received from the central energy coordinator. The local energy controller can then determine whether some of the energy consumption during the higher-cost time periods can be reduced by shifting some of the energy consumption to lower-cost time periods. For example, the local energy controller can determine the energy devices that are projected to be consuming energy during the higher-cost time periods. The local energy controller can then shift some of the energy consumption from the higher-cost time periods to the lower-cost time periods to create an energy consumption schedule that reduces the overall energy costs for the local energy system. The flow continues at block 604.

At block 604, the local energy controller receives energy access control information from the central energy coordinator. The energy access control information can include one or more types of energy access control parameters, such as ramp rate control parameters, token bucket parameters, access probability parameters, and backoff/retry time window parameters. In some implementations, the energy access control information may include different energy access control parameters for different types or categories of energy devices. For example, a first energy access control parameter can be assigned to energy devices in the best effort category, a second energy access control parameter can be assigned to energy devices in the human comfort category, and a third energy access control parameter can be assigned to the energy devices in the time-sensitive category. The flow continues at block 606.

At block 606, the local energy controller modifies the energy consumption schedule during an energy pricing transition period based, at least in part, on the energy access control information to manage a projected energy demand increase during the energy pricing transition period of the distributed energy network. As described above, the energy pricing transition period is a period of time when the energy pricing changes from a relatively high price to a relatively low price (or vice versa). The projected energy demand increase may be an energy demand spike that is projected to occur during the energy pricing transition period. The local energy controller (in conjunction with other local energy controllers in the distributed energy network) may modify the energy consumption schedule during the energy pricing transition period to reduce or smooth out the projected energy demand spike in the distributed energy network. As described previously, in one example, based on ramp rate control parameters, the local energy controller may change the rate of energy access (e.g., below a maximum rate) during the energy pricing transition period by some or all of the energy consuming devices in the local energy system. In another example, based on token bucket parameters, access probability parameters, and/or backoff/retry time window parameters, the local energy controller may modify the energy consumption schedule during the energy pricing transition period by distributing the start times of the energy consumption of different energy devices across a longer period of time to distribute the energy consumption more evenly to reduce the projected energy demand spike.

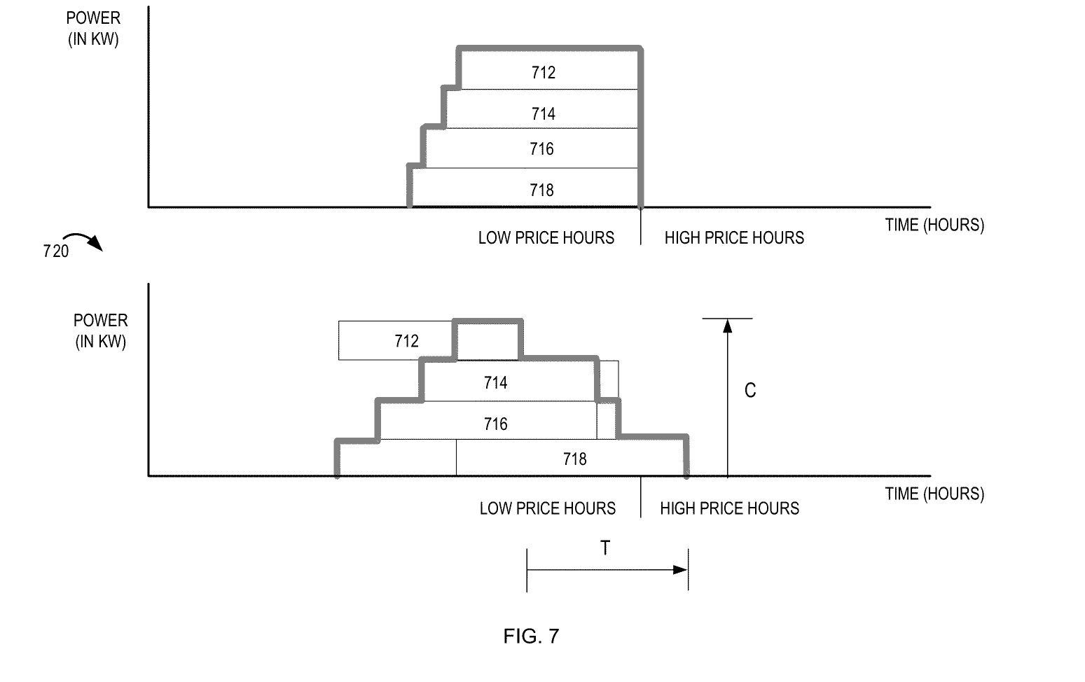

FIG. 7 depicts a graph 710 and a graph 720 illustrating an example of energy consumption management by local energy controllers to modify the energy consumption schedules based on an energy access control parameter to reduce a projected energy demand spike in a distributed energy network. In this particular example, the local energy controllers modify the energy consumption for pre-cooling a home to distribute the energy consumption differently among the different local energy systems. In this example, the energy access parameter received at the local energy controllers from the central energy coordinator is a ramp rate control parameter T that controls the ramp rate of the total load C. For example, the ramp rate control parameter T changes the timing of the start time of the energy consumption by either delaying or advancing the energy consumption by between 0-T/2 minutes (or hours), as will be further described below.

Graph 710 shows the original energy consumption schedules 712-718 managed by the local energy controllers for pre-cooling their respective homes. As shown in graph 710, even though the duration of the energy consumption schedules 712-718 to pre-cool each of the homes varies, the energy consumption schedules 712-718 are started at different times such that the energy consumption ends before the price of energy increases in order to optimize the energy costs. However, since all of the homes that implement the energy consumption schedules 712-718 follow a similar pattern of energy consumption during an energy pricing transition period, additional homes may follow the same pattern. As described previously, if a large number of homes have similar energy consumption schedules that follow a similar pattern, an energy demand spike may occur in the distributed energy network.

Graph 720 illustrates one example of how the local energy controllers can modify the energy consumption schedules 712-718 based on the ramp rate control parameter T to distribute the energy consumption differently for their respective homes. When an energy consumption schedule is set to start at time X, each local energy controller can independently delay or advance the start time of the energy consumption between 0-T/2 minutes (or seconds). In one example, each local energy controller may independently and randomly determine whether to delay or advance the start time and also the amount of time within the allotted range to delay or advance the start time. If the parameter T is updated when the time is already within T/2 of the start time, the local energy controller may delay the start time of the energy consumption by time T from the time the parameter T is updated. As shown in graph 720, the start times for the energy consumption schedules 712, 714, and 716 for their respective homes are advanced in time by different amounts of time, and the start time for the energy consumption schedule 718 for its respective home is delayed in time. With the modified schedules, most of the energy needed (i.e., the total load C) to pre-cool the homes is still received within the low price hours, and the ramp up rate to the total load C is reduced by distributing the start times of the energy consumption schedules 712-718 over a longer period of time. As shown in graph 720, with the reduced ramp up rate and the distributed energy consumption schedules, the combined energy consumption by all of the homes at most time instants shown in graph 720 is less than the total load C. Although one of the homes (i.e., the home with the energy consumption schedule 718) may have a slight increase in the energy cost to pre-cool the home with the modified energy consumption schedule, most of the energy consumption schedule still remains during the optimal low price hours, and the energy demand spike may be reduced or smoothed out for the benefit of the distributed energy network.

It should be understood that FIGS. 1-7 are examples meant to aid in understanding embodiments and should not be used to limit embodiments or limit scope of the claims. Embodiments may comprise additional system/network components, different system/network components, and/or may perform additional operations, fewer operations, operations in a different order, operations in parallel, and some operations differently. For example, in some embodiments, a local energy controller 150 may be located remotely, but may still perform the various operations described herein with reference to FIGS. 1-8 for managing the energy demand and energy consumption of a local energy system 120. For example, the local energy controller 150 may be implemented in a server that is remote from the corresponding local energy system 120 (i.e., the server may not be located in the same premises as the local energy system 120). Even though the server is located remotely, the local energy controller 150 may perform the same operations described herein with reference to FIGS. 1-8. For example, the local energy controller 150 may collect data from the energy devices 122 of the local energy system 120, provide projected energy demand information to the central energy coordinator 110, receive energy pricing and access control information from the central energy coordinator 110, determine whether to modify the energy consumption schedule of the local energy system 120, etc. In one embodiment, the distributed energy network 100 may include one or more networks of servers for implementing the local energy controllers 150 for the various local energy systems 120. Each server may implement multiple local energy controllers 150 for multiple local energy systems 120. In one embodiment, even though the server may implement the local energy controller 150 remotely, the local energy system 120 may include a thin client device (which may be referred to as a local energy client) that may communicate locally with the energy devices 122, collect data from the energy devices 122, and provide the data to the local energy controller 150 for processing. In one example, the local energy client may also collect information from the central energy coordinator 110 and provide the information to the local energy controller 150 for processing. In this embodiment, the local energy controller 150 may be implemented in a distributed manner across the remote server and the local energy client. In one example, with reference to FIG. 3, the local energy client may be implemented by the thermostat 375 and/or the router 380. It is noted, however, that the local energy client may be implemented as a standalone device or by other devices in the local energy system 120 (e.g., a smart appliance 122).

As will be appreciated by one skilled in the art, aspects of the present disclosure may be embodied as a system, method, or computer program product. Accordingly, aspects of the present disclosure may take the form of an entirely hardware embodiment, a software embodiment (including firmware, resident software, micro-code, etc.) or an embodiment combining software and hardware aspects that may all generally be referred to herein as a “circuit,” “module,” “unit,” or “system.” Furthermore, aspects of the present disclosure may take the form of a computer program product embodied in one or more computer readable medium(s) having computer readable program code embodied thereon.

Any combination of one or more non-transitory computer readable medium(s) may be utilized. Non-transitory computer-readable media comprise all computer-readable media, with the sole exception being a transitory, propagating signal. The non-transitory computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

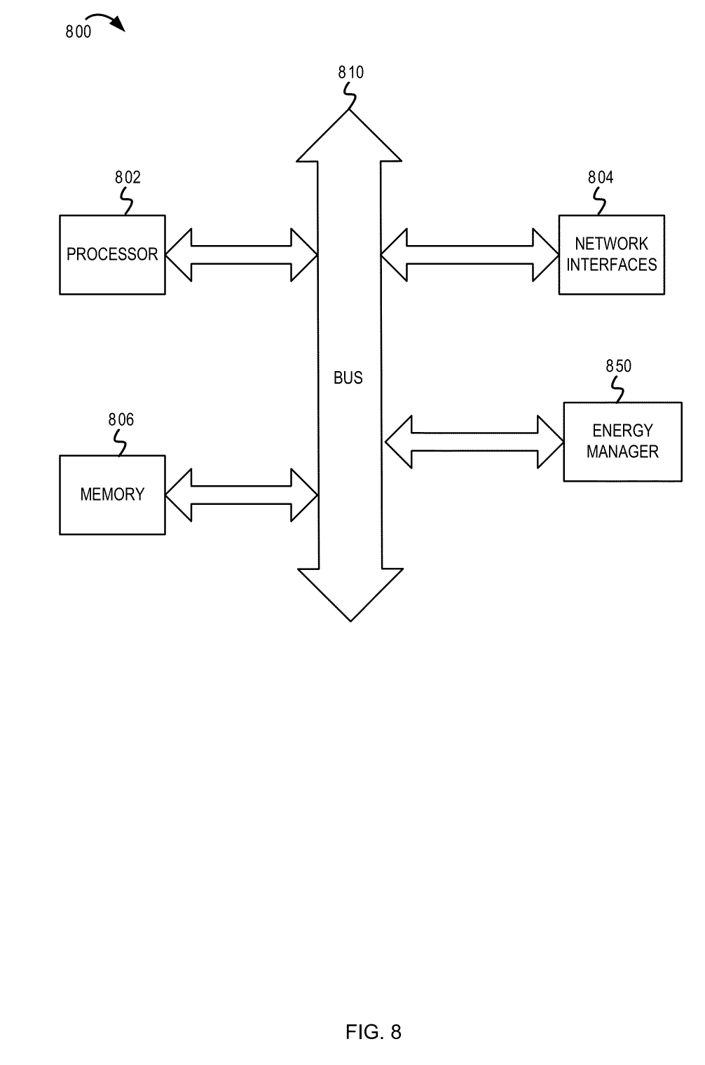

FIG. 8 is an example block diagram of an electronic device 800 including an energy manager 850. The electronic device 800 includes a processor 802 (possibly including multiple processors, multiple cores, multiple nodes, and/or implementing multi-threading, etc.). The electronic device 800 includes memory 806. The memory 806 may be system memory (e.g., one or more of cache, SRAM, DRAM, zero capacitor RAM, Twin Transistor RAM, eDRAM, EDO RAM, DDR RAM, EEPROM, NRAM, RRAM, Silicon-Oxide-Nitride-Oxide-Silicon (SONOS), PRAM, etc.) or any one or more of the above already described possible realizations of computer-readable storage media. The electronic device 800 also includes a bus 810 (e.g., Peripheral Component Interconnect (PCI), Industry Standard Architecture (ISA), PCI-Express, HyperTransport®, InfiniBand®, NuBus, Advanced High-performance Bus (AHB), Advanced eXtensible Interface (AXI), etc.), and network interfaces 804. The processor 802, the memory 806, and the network interfaces 804 are coupled with the bus 810. The network interfaces 804 may include a wireless network interface (e.g., a wireless local area network (WLAN) interface, a Bluetooth® interface, a WiMAX interface, a ZigBee® interface, a Wireless Universal Serial Bus (USB) interface, etc.) and/or a wired network interface (e.g., a PLC interface, an Ethernet interface, etc.).

In some embodiments, the energy manager 850 of the electronic device 800 may perform any of the previously described functions performed by the local energy controller 150 of FIGS. 1-7 for managing energy demand and energy consumption in a local energy system. In some embodiments, energy manager 850 of the electronic device 800 may perform any of the previously described functions performed by the central energy coordinator of FIGS. 1-7 for distributed energy demand management in a distributed energy network.

Any one of these functionalities may be partially (or entirely) implemented in hardware and/or on the processor 802. For example, the functionality may be implemented with a system-on-a-chip (SoC), an application specific integrated circuit (ASIC), in logic implemented in the processor 802, in a co-processor on a peripheral device or card, etc. Further, realizations may include fewer or additional components not illustrated in FIG. 8 (e.g., video cards, audio cards, additional network interfaces, peripheral devices, etc.). The processor 802, the memory 806, and the network interfaces 804 are coupled to the bus 810. Although illustrated as being coupled to the bus 810, the memory 806 may be coupled to the processor 802.

While the embodiments are described with reference to various implementations and exploitations, it will be understood that these embodiments are illustrative and that the scope of the disclosure is not limited to them. In general, techniques for distributed energy demand management as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

What is claimed is:

1. A method for managing energy demand comprising:
determining, by a local energy controller of a local energy system, energy pricing information of a distributed energy network for a first time period;
determining projected energy demand information for a plurality of energy devices of the local energy system for the first time period based, at least in part, on the energy pricing information for the first time period; and
providing the projected energy demand information to a central energy coordinator of the distributed energy network.

2. The method of claim 1, wherein determining the projected energy demand information for the first time period comprises:
determining an energy consumption schedule for the plurality of energy devices for the first time period based, at least in part, on the energy pricing information for the first time period; and
determining the projected energy demand information for the first time period based, at least in part, on the energy consumption schedule for the first time period.

3. The method of claim 2, further comprising:
determining a local energy generation schedule for generating energy using a local energy generator of the local energy system during the first time period; and
determining the projected energy demand information for the first time period based, at least in part, on the energy consumption schedule for the first time period and the local energy generation schedule for the first time period.

4. The method of claim 2, wherein determining the energy consumption schedule for the first time period is based on at least one member of the group consisting of a dynamic energy pricing schedule, energy consumption information associated with the local energy system, and user information associated with the local energy system.

5. The method of claim 4, wherein,
the energy consumption information is at least one member of the group consisting of user-programmed energy consumption schedules, user-programmed energy consumption preferences, historical energy consumption information, and local energy generation schedules, and
the user information is at least one member of the group consisting of user occupancy patterns and user energy usage patterns.

6. The method of claim 1, further comprising:
determining an energy consumption schedule for the plurality of energy devices based, at least in part, on the energy pricing information, wherein the energy pricing information is received from the central energy coordinator of the distributed energy network;
receiving energy access control information from the central energy coordinator, wherein the energy access control information indicates an energy pricing transition period having a projected energy demand increase; and
modifying the energy consumption schedule during the energy pricing transition period based, at least in part, on the energy access control information to manage the projected energy demand increase during the energy pricing transition period of the distributed energy network.

7. The method of claim 6, wherein modifying the energy consumption schedule comprises modifying a rate of energy consumption during the energy pricing transition period for at least a subset of the plurality of energy devices based, at least in part, on the energy access control information.

8. The method of claim 6, wherein modifying the energy consumption schedule comprises shifting a timing of energy consumption for at least a subset of the plurality of energy devices based, at least in part on the energy access control information.

9. The method of claim 6, wherein the energy access control information comprises at least one member of the group consisting of a ramp rate control parameter, a token bucket parameter, a backoff time window parameter, and an energy access probability parameter.

10. The method of claim 6, wherein the plurality of energy devices includes a first category of energy devices and a second category of energy devices, and the energy access control information includes first access control parameters and second access control parameters, wherein modifying the energy consumption schedule comprises:
modifying the energy consumption schedule for the first category of energy devices based, at least in part, on the first access control parameters; and
modifying the energy consumption schedule for the second category of energy devices based, at least in part, on the second access control parameters.

11. The method of claim 1, further comprising:
determining an energy consumption schedule for the plurality of energy devices based, at least in part, on the energy pricing information received from the central energy coordinator, wherein the plurality of energy devices includes a first category of energy devices and a second category of energy devices, and
wherein determining the energy consumption schedule comprises at least one member of the group consisting of
scheduling of energy consumption for the first category of energy devices having a first priority before scheduling of energy consumption for the second category of energy devices having a second priority, wherein the first priority is higher than the second priority, and
shifting the scheduling of energy consumption for the second category of energy devices from a second time period having a first energy cost to a third time period having a second energy cost, wherein the second energy cost is lower than the first energy cost.

12. A method for managing energy demand comprising:
receiving, at a central energy coordinator of a distributed energy network, projected energy demand information from a plurality of local energy controllers of the distributed energy network;
determining energy supply information for the distributed energy network;
determining energy pricing information for the distributed energy network based, at least in part, on the projected energy demand information and the energy supply information; and
determining energy access control information based, at least in part, on a projected energy demand increase during an energy pricing transition period.

13. The method of claim 12, further comprising:
determining an aggregate of the projected energy demand information received from the plurality of local energy controllers; and
determining the projected energy demand increase during the energy pricing transition period from the aggregate of the projected energy demand information.

14. The method of claim 12, wherein the energy pricing transition period is a time period between a first time instant having a first energy price and a second time instant having a second energy price, wherein a difference between the first energy price and the second energy price exceeds a threshold.

15. The method of claim 12, further comprising providing the energy access control information to the plurality of local energy controllers to reduce the projected energy demand increase during the energy pricing transition period.

16. The method of claim 12, further comprising providing the energy pricing information to the plurality of local energy controllers.

17. The method of claim 12, wherein determining the energy pricing information comprises determining a projected energy pricing schedule for a first time period based, at least in part, on the projected energy demand information for the first time period and the energy supply information for the first time period.

18. The method of claim 12, further comprising determining that the projected energy demand increase is a projected energy demand spike, wherein determining the energy access control information is based on at least one characteristic of the projected energy demand spike.

19. The method of claim 18, wherein determining that the projected energy demand increase is the projected energy demand spike is based, at least in part, on determining that a rate of the projected energy demand increase exceeds a threshold rate.

20. The method of claim 18, wherein the at least one characteristic of the projected energy demand spike comprises at least one member of the group consisting of a ramp up rate associated with the projected energy demand spike and a change in energy demand associated with the projected energy demand spike.

21. The method of claim 12, wherein receiving projected energy demand information comprises:
receiving a plurality of projected energy demand schedules from the plurality of local energy controllers; and
determining an aggregate of the plurality of projected energy demand schedules that indicates a total projected energy demand for the distributed energy network during a plurality of time increments of a first time period.

22. A local energy controller for managing energy demand comprising:
a processor; and
a memory to store instructions, which when executed by the processor, cause the local energy controller to:
determine energy pricing information of a distributed energy network for a first time period;
determine projected energy demand information for a plurality of energy devices of a local energy system for the first time period based, at least in part, on the energy pricing information for the first time period; and
provide the projected energy demand information to a central energy coordinator of the distributed energy network.

23. The local energy controller of claim 22, wherein the instructions, which when executed by the processor, cause the local energy controller to:
determine an energy consumption schedule for the plurality of energy devices for the first time period based, at least in part, on the energy pricing information for the first time period; and
determine the projected energy demand information for the first time period based, at least in part, on the energy consumption schedule for the first time period.

24. The local energy controller of claim 23, wherein the instructions, which when executed by the processor, cause the local energy controller to:
determine a local energy generation schedule for generating energy using a local energy generator of the local energy system during the first time period; and
determine the projected energy demand information for the first time period based, at least in part, on the energy consumption schedule for the first time period and the local energy generation schedule for the first time period.

25. The local energy controller of claim 22, wherein the instructions, which when executed by the processor, cause the local energy controller to:
determine an energy consumption schedule for the plurality of energy devices based, at least in part, on the energy pricing information, wherein the energy pricing information is received from the central energy coordinator of the distributed energy network;
receive energy access control information from the central energy coordinator, wherein the energy access control information indicates an energy pricing transition period having a projected energy demand increase; and
modify the energy consumption schedule during the energy pricing transition period based, at least in part, on the energy access control information to manage the projected energy demand increase during the energy pricing transition period of the distributed energy network.

26. The local energy controller of claim 25, wherein the instructions, which when executed by the processor, cause the local energy controller to modify the energy consumption schedule comprise instructions to modify a rate of energy consumption during the energy pricing transition period for at least a subset of the plurality of energy devices based, at least in part, on the energy access control information.

27. The local energy controller of claim 25, wherein the instructions, which when executed by the processor, cause the local energy controller to modify the energy consumption schedule comprise instructions to shift a timing of energy consumption for at least a subset of the plurality of energy devices based, at least in part on the energy access control information.

28. The local energy controller of claim 25, wherein the energy access control information comprises at least one member of the group consisting of a ramp rate control parameter, a token bucket parameter, a backoff time window parameter, and an energy access probability parameter.

29. The local energy controller of claim 25, wherein the plurality of energy devices includes a first category of energy devices and a second category of energy devices, and the energy access control information includes first access control parameters and second access control parameters, wherein the instructions, which when executed by the processor, cause the local energy controller to modify the energy consumption schedule comprise instructions to:
modify the energy consumption schedule for the first category of energy devices based, at least in part, on the first access control parameters; and
modify the energy consumption schedule for the second category of energy devices based, at least in part, on the second access control parameters.

30. A central energy coordinator for managing energy demand comprising:
a processor; and
a memory to store instructions, which when executed by the processor, cause the central energy coordinator to:
receive projected energy demand information from a plurality of local energy controllers of a distributed energy network;
determine energy supply information for the distributed energy network;
determine energy pricing information for the distributed energy network based, at least in part, on the projected energy demand information and the energy supply information; and
determine energy access control information based, at least in part, on a projected energy demand increase during an energy pricing transition period.

31. The central energy coordinator of claim 30, wherein the instructions, which when executed by the processor, cause the central energy coordinator to:
determine an aggregate of the projected energy demand information received from the plurality of local energy controllers; and
determine the projected energy demand increase during the energy pricing transition period from the aggregate of the projected energy demand information.

32. The central energy coordinator of claim 30, wherein the energy pricing transition period is a time period between a first time instant having a first energy price and a second time instant having a second energy price, wherein a difference between the first energy price and the second energy price exceeds a threshold.

33. The central energy coordinator of claim 30, wherein the instructions, which when executed by the processor, cause the central energy coordinator to provide the energy access control information to the plurality of local energy controllers to reduce the projected energy demand increase during the energy pricing transition period.

34. The central energy coordinator of claim 30, wherein the instructions, which when executed by the processor, cause the central energy coordinator to:
receive a plurality of projected energy demand schedules from the plurality of local energy controllers; and
determine an aggregate of the plurality of projected energy demand schedules that indicates a total projected energy demand for the distributed energy network.

35. A non-transitory machine-readable storage medium having machine executable instructions stored therein, the machine executable instructions comprising instructions to:
determine, by a local energy controller of a local energy system, energy pricing information of a distributed energy network for a first time period;
determine projected energy demand information for a plurality of energy devices of the local energy system for the first time period based, at least in part, on the energy pricing information for the first time period; and
provide the projected energy demand information to a central energy coordinator of the distributed energy network.

36. The non-transitory machine-readable storage medium of claim 35, wherein the instructions to determining the projected energy demand information for the first time period comprise instructions to:
determine an energy consumption schedule for the plurality of energy devices for the first time period based, at least in part, on the energy pricing information for the first time period; and
determine the projected energy demand information for the first time period based, at least in part, on the energy consumption schedule for the first time period.

37. The non-transitory machine-readable storage medium of claim 36, further comprising instructions to:
determine a local energy generation schedule for generating energy using a local energy generator of the local energy system during the first time period; and
determine the projected energy demand information for the first time period based, at least in part, on the energy consumption schedule for the first time period and the local energy generation schedule for the first time period.

38. The non-transitory machine-readable storage medium of claim 35, further comprising instructions to:
determine an energy consumption schedule for the plurality of energy devices based, at least in part, on the energy pricing information, wherein the energy pricing information is received from the central energy coordinator of the distributed energy network;
receive energy access control information from the central energy coordinator, wherein the energy access control information indicates an energy pricing transition period having a projected energy demand increase; and
modify the energy consumption schedule during the energy pricing transition period based, at least in part, on the energy access control information to manage the projected energy demand increase during the energy pricing transition period of the distributed energy network.

39. The non-transitory machine-readable storage medium of claim 38, wherein the instructions to modify the energy consumption schedule comprise instructions to modify a rate of energy consumption during the energy pricing transition period for at least a subset of the plurality of energy devices based, at least in part, on the energy access control information.

40. The non-transitory machine-readable storage medium of claim 38, wherein the instructions to modify the energy consumption schedule comprise instructions to shift a timing of energy consumption for at least a subset of the plurality of energy devices based, at least in part on the energy access control information.
